(19) United States
(12) Patent Application Publication
(10) Pub. No.: US 2008/0243851 A1
(43) Pub. Date: Oct. 2, 2008

(54) Multi-User Conditional Access to a Content Item

(75) Inventors: Koen Hendrik Johan Vrielink, Eindhoven (NL); Franciscus Lucas Antonius Johannes Kamperman, Eindhoven (NL); Lukasz Marek Szostek, Eindhoven (NL); Mark Henricus Verberkt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,268

(22) PCT Filed: Mar. 18, 2005
(86) PCT No.: PCT/IB2005/050942

§ 371 Date: Sep. 25, 2006

(30) Foreign Application Priority Data
Mar. 26, 2004 (EP) 04101257.6

(51) Int. Cl. G06F 1/00

(52) U.S. Cl. 707/9

(57) ABSTRACT

This invention relates to a system and method of providing conditional access to a data content item for a number of users, where the data content item is associated with a digital right that provides a user the right to access the data content item a predetermined number of times. The data content item is arranged in a number of subparts and the digital right is arranged in a number of sub-rights (100), initially designated as available sub-rights (101), where each available sub-right (101) provides a user the right to access a subpart of the data content item. When a user is granted (new) access to a content item a number of available sub-rights (101) is reserved. In this way, it is ensured in a very simple way that if a user in a multi-user scenario pauses access (also for a prolonged time) to the data content item then there will be sub-rights available so that the content may be accessed at a later time even if another user of the group starts spending sub-rights immediately after.

The invention relates to a system of providing conditional access to a data content item for a number of users. The invention further relates to a method for providing conditional access to a data content item for a number of users. Further, the invention relates to a computer readable medium having stored thereon instructions for causing one or more processing units to execute the method according to the invention.

In recent years, the amount of content protection systems is growing in a rapid pace. Some of these systems only protect the content against illegal copying, while others are also prohibiting the user to get access to the content. The first category is usually called Copy Protection (CP) systems. CP systems have traditionally been the main focus for consumer electronics (CE) devices, as this type of content protection is thought to be cheaply implemented and does not need bi-directional interaction with the content provider. Some examples are the Content Scrambling System (CSS), the protection system of DVD ROM discs and DTCP (a protection system for IEEE 1394 connections).

The second category is known under several names. In the broadcast world, systems of this category are generally known as conditional access (CA) systems, while in the Internet world they are generally known as Digital Rights Management (DRM) systems.

Countable rights, i.e. right associated with a number-of uses, in a DRM/CA system pose a technical challenge. If a DRM/CA system (forth only denoted DRM system) completely retracted a right to watch a purchased content item upon starting the content, then it would not be possible to stop and continue at a later time, which is not fair to a user who validly has paid for viewing, hearing, rendering, etc. the entire content. If the system would retract the right upon reaching the end of the content, then a user could stop watching, hearing, rendering or the like near the end and rewind and thereby save the right, which is not fair to the content item provider as the user has used almost the entire content without having its associated right consumed. Therefore neither of these implementations is acceptable.

An acceptable implementation of a DRM system that supports such scenarios is to break up a content item into smaller subunits/sub-parts (e.g. scenes, tracks or the like) and where a right to watch the content item completely only once is broken up into several smaller sub-rights, where each sub-right entitles a user to watch a single sub-part (a single time). Usually a provider does not care if a user watches the same scene ten time or all scenes once; therefore it is acceptable that a DRM system simply maintains a collection of sub-rights and reduces/consumes them each time that for instance a (new or previous) sub-part has been entered/rendered/accessed. A variant is that a user can only watch, hear, render, access, etc. sub-parts in an increasing order to prevent that he/she cannot watch, hear, render, access, etc. the end of the content item anymore after having watched, heard, rendered, access, etc. too many sub-parts from the beginning of the content item. Such a mechanism is described for a pay-tv system in European patent application publication number 99204470 and PCT application WO 01/47266 (attorney docket PHN017840) by the same applicant. Another mechanism is used in connection with DVD audio where a piece of music is divided into three pieces. If a part of every piece has been played-back then the right is counted/consumed.

The implementation of European patent application publication number 99204470 and PCT application WO 01/47266 (attorney docket PHN017840) enables pause and continuation quite naturally, as the user consumes his/her right(s) gradually with the content. A user can simply continue consumption of both content and rights when and from where he/she pleases.

Communication with the user about the remaining rights is also quite natural. A DRM system should be aware of the number of sub-parts in a content item and the number of remaining sub-rights. The division of these two numbers gives the number of times a user can still watch, hear, render, access, etc. the content completely.

However, a drawback of this implementation arises in multi-user scenarios, where a group of users has access to a group of rights. Such groups of user could e.g. be the occupants of a house-hold, members of an Authorized Domain, etc. Since the DRM system only maintains a record of the still available sub-rights, it has no way of knowing how many sub-rights are still needed for users who are currently somewhere in the middle of consuming the content and who expect to finish it at a later time. This can e.g. lead to a situation where sub-rights allocated to new users results in that no sub-rights are available when a given user wants to resume consuming the content. Further, if a group of users has acquired the right to watch a given content item once, and one user is watching the content and a second user starts the content, this results in the situation that none of the users can watch the content till the end. Additionally, an inappropriate situation could arise when a user gives way the sub-rights to watch a movie once from the beginning to the end, while some other user is in the middle of watching it, since it is not ensured that the user in the middle of watching it is able to complete it.

It is an object of the invention to provide a system and corresponding method of providing conditional access to a data content item for a number of users that solves the above-mentioned shortcomings of prior art. A further object is to provide this in a simple, flexible and efficient way.

These objects, among others, are achieved by a method (and corresponding system) of providing conditional access to a data content item for a number of users, where the data content item is associated with a digital right, the digital right providing any user of a group of users the right to access the data content item a predetermined number of times, and where the data content item is arranged in a number of subparts and the digital right is arranged in a number of sub-rights, initially designated as available sub-rights, each available sub-right providing any user of the group of users the right to access a subpart of the data content item, and wherein the method comprises the steps of:

granting a user of the group of users access to the data content item if the associated digital right or the available sub-right(s) allows this, and

reserving a number of available sub-rights, resulting in a number of reserved sub-rights, when a user of the group of users initiates granted access to the data content item as a new access session.

Hereby, it is ensured in a very simple way that if a user in a multi-user scenario pauses access (also for a prolonged time) to the data content item then there will be sub-rights available so that the content may be accessed at a later time even if another user of the group starts spending sub-rights immediately after.

In a preferred embodiment, the step of reserving a number of available sub-rights comprises reservation of a number of sub-rights that is required to access the complete content item once if there are sufficiently many available sub-rights.

In this way, it is ensured that there still are enough sub-rights available to a user that has paused access to a data content item for finishing access to the rest of the data content item.

In one embodiment, the method further comprises

consuming one available sub-right or a reserved sub-right when a sub-part is accessed by a user of the group of users resulting in a spent sub-right that no longer is available.

In one embodiment, the specific available sub-right only allows access to a specific sub-part of the data content item, or that a specific available sub-right allows access to any sub-part of the data content item.

In one embodiment, the step of reserving a number of available sub-rights comprises

reserving the number of sub-rights so that only the user that initiated granted access to the data content item is able to continue access to the data content item using reserved sub-rights.

In this way, it is ensured that only the user that paused the access to the data content is able to continue access at a later time, i.e. during a continued session.

In an alternative embodiment, the step of reserving a number of available sub-rights comprises

reserving the number of sub-rights so that all the users belonging to the group comprising the user that initiated granted access to the data content item is able to continue access to the data content item using reserved sub-rights.

In this way, it is ensured that all the users of the group may continue access at a later time.

In one embodiment, the step of reserving a number of available sub-rights is only done when the user that initiated granted access is expected to complete access to substantially all of the data content item.

In this way, a reservation (and thereby ‘locking’) of sub-rights is only done when a user is expected to or interested in completing the entire data content item which avoids reserving sub-rights that are not going to be needed. That the user is expected to or interested in completing the content later may be determined on the basis of the digital right, by feedback obtained from the user, etc.

In one embodiment, the method further comprises the step of

canceling, by a user, the reservation of a number of reserved sub-rights thereby freeing sub-rights resulting a number of available subrights for the group of users, where only the user that initiated granted access to the content item is allowed to cancel or where all the users belonging to the group comprising the user that initiated granted access to the data content item is allowed to cancel.

In this way, the user has the option of canceling the reservation of sub-rights thereby freeing sub-rights for the group of users, e.g. if the user changes his/her mind and do not wish to complete access to the content. Only the still reserved and not used sub-rights may be cancelled. Preferably, only the user that initiated the access has the option of canceling. Alternatively, all the users belong to the group of users comprising the user that initiated the access has the option of canceling.

Advantageous embodiments of the system according to the present invention are defined in the sub-claims and are described in detail in the following. The embodiments of system correspond to the embodiments of the method and have the same advantages for the same reasons.

Further, the invention also relates to a computer readable medium having stored thereon instructions for causing one or more processing units to execute the method according to the present invention.

In the following, content item will be used for data content item.

These and other aspects of the invention will be apparent from and elucidated with reference to the illustrative embodiments shown in the drawings, in which:

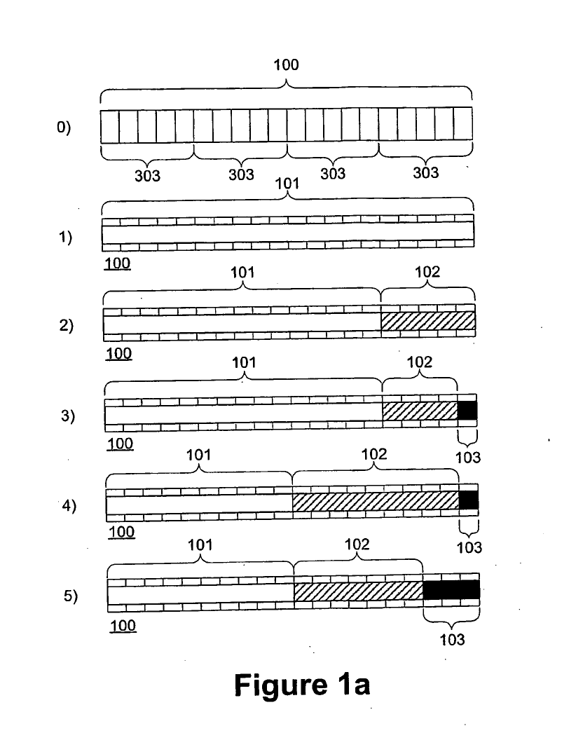

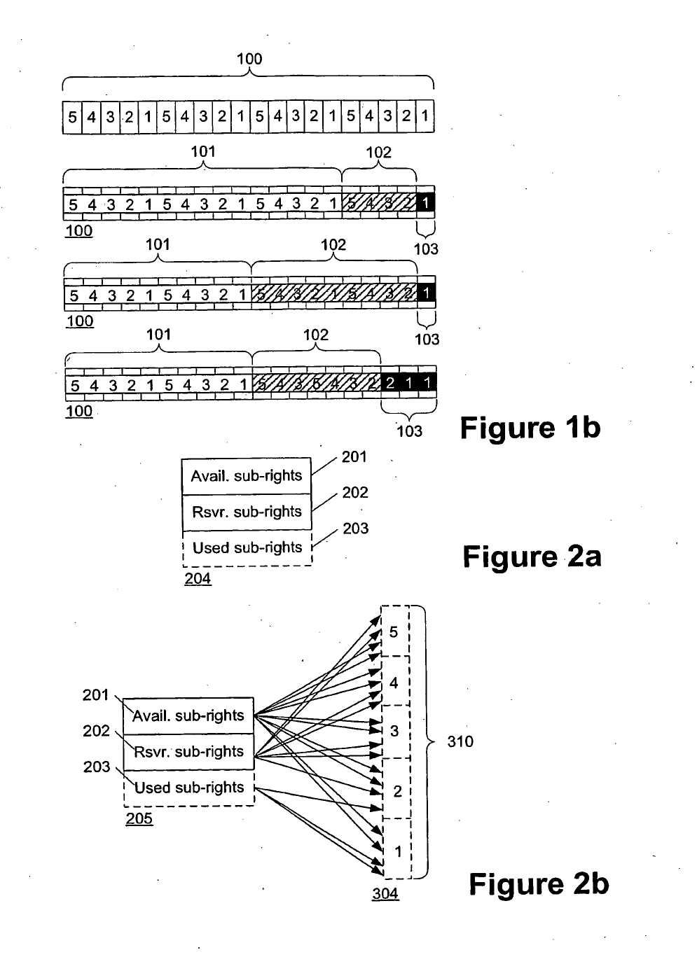

FIG. 1a schematically illustrates sub-rights for a given content item according to the present invention;

FIG. 1b schematically illustrates subrights for a given content item according to an alternative embodiment of the present invention;

FIG. 2a schematically illustrates one example of a (part of a) data structure according to the present invention;

FIG. 2b schematically illustrates one example of a (part of a) data structure according to an alternative embodiment of the present invention;

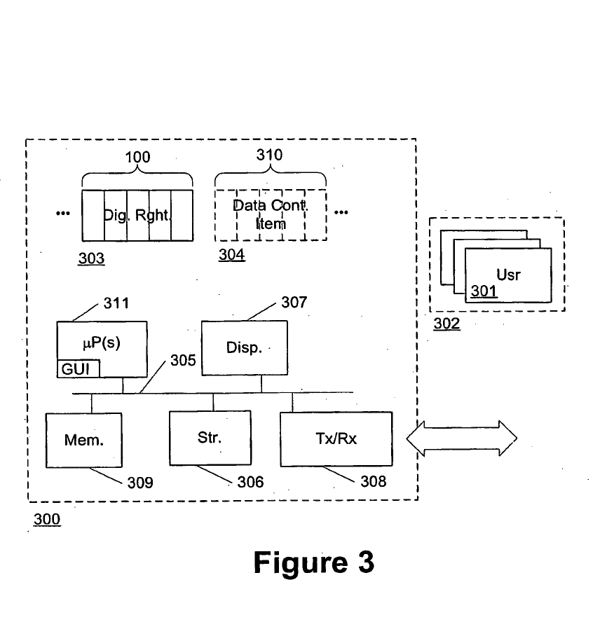

FIG. 3 schematically illustrates an embodiment of a system according to the present invention;

Throughout the figures, same reference numerals indicate similar or corresponding features. Some of the features indicated in the drawings are typically implemented in software, and as such represent software entities, such as software modules or objects.

FIG. 1 a schematically illustrates sub-rights for a given content item according to the present invention.

A content item (not shown; see 304 in FIG. 2 or 3) according to the present invention is split up (not necessarily physically) or arranged in sub-parts (not shown; see 310 in FIG. 2 or 3) and a related digital right (303) providing the right to access the entire content a single time is split up into sub-rights (100), where each sub-right (100) entitles a user (not shown; see 301 in FIG. 3) that has acquired the related right (e.g. directly or by being part of a group of users (not shown; see 302 in FIG. 3) that has acquired the related right) to watch a single sub-part of the content item. The sub-right (100) may give the user the right to a specific sub-part or alternatively any sub-part e.g. depending on the implementation or on the type of the content item. In situations where a content provider does not care whether a user, who-has purchased a digital right to watch an entire movie once consisting of 10 sub-parts, watches one sub-part 10 times or the entire movie it is sufficient that a sub-right specifies the right to watch any sub-part If the content provider does care the sub-right should specify a specific sub-part.

A content item may for example be one or more movies, one or more audio tracks, one or more web-pages, one or more photos, one or more slide shows, one or more multi-media presentations, etc. and/or a combinations/variations thereof.

The splitting or arrangement in sub-parts of a given content item may be done according to many different schemes. Examples are e.g. splitting/arranging on the basis of time (e.g. each sub-part lasts 5 minutes), on the basis of the amount of data (e.g. each sub-part represents 1 MByte of data), in a content related way (e.g. each sub-part represents a scene of a movie, a track of a music piece or a web-site e.g. in a broadcast data carrousel), etc. and/or combinations thereof.

According to the present invention, a number of available sub-rights (101) are reserved resulting in a number of reserved sub-rights (102) when a user belonging to a group of users initiates the rendering, viewing, hearing, access (forth only denoted access) of/to a content item and it has been validated that the user has the right to do so (using the digital right or one or more sub-rights). By available sub-rights (101) is to be understood the number of sub-rights (100) that have been allocated to or purchased by the user (or to/by a group of users comprising the user) which have not already been consumed, spent, counted, etc. Preferably, a number of sub-rights being equal to the number of sub-parts needed for a complete access to the given content item are reserved (if available). E.g. if a content item is divided into 5 sub-units then 5 sub-rights are reserved (if available). In this way, it is ensured in a very simple way that if the user pauses access (also for a prolonged time) then there will be enough sub-rights available so the (rest of the) entire content may be accessed at a later time even if another user of the group starts spending sub-rights immediately after. Alternatively, a number of sub-rights different than the number of sub-units may be reserved, although this. is not as optimal. Examples are reserving 500% or 90% of the sub-units of a content item. A different number of sub-rights may also be reserved in the situation where the user initiates access to the content item at another location than the start, e.g. if the user initiates access at the third sub-part then sub-rights for the remaining sub-parts could be reserved.

The reservation may be done exclusively for the specific user that initiated the access to the content item, i.e. only the specific user may use the reserved sub-rights. Alternatively and just as applicable, the reservation may be done for all the users of the group that the user that initiated the access is part of.

One (reserved) sub-right will then be consumed or used for each sub-part of the content item that the user accesses resulting in a used sub-right (103). Different schemes for this may be employed. One example is to specify that a sub-right is used when the user starts access to the sub-part or has accessed a small part of the sub-part. Another example is to consume the sub-right when the user is near the end of the sub-part or has accessed the sub-part completely and is moving to the next sub-part. Yet another example is to consume the sub-right at access to a middle part of the sub-part and variations/combinations thereof. It is not necessary to keep track of the spent sub-rights (103).

If the user chooses at some point to pause the access to the data content the preferably remaining sub-rights will stay reserved and available until access is continued/resumed. In one embodiment, the user also has the option of manually canceling the reservation of sub-rights thereby freeing sub-rights for the group of users. Only the still reserved and not used sub-rights may be cancelled. Preferably, only the user that initiated the access has the option of canceling.

In a preferred embodiment, the reservation is only done when the user initiating the access is expected to complete access to substantially the entire content item. In this way, a reservation (and thereby ‘locking’) of sub-rights is only done when a user is expected to be interested in completing the entire data content item which avoid reserving sub-rights that is not going to be needed. That the user is expected to be interested in completing the content later may be determined on the basis of the digital right (e.g. by specifying that pausing is not allowed), by feedback obtained from the user, etc.

As a simple example to illustrate one embodiment of the invention, a group of users have bought the digital rights to watch a certain movie 4 times. The movie in this example is split up into 5 sub-units (scenes) giving a total of 20 acquired sub-rights, where, according to this embodiment, each sub-right gives the right to access any sub-part. This is illustrated in FIG. 1 a situation 0), which illustrates a number (20 in this example) of sub-rights (100).

All sub-rights (100) are initially, i.e. after the purchase has been done, available as none have been used yet. This is illustrated in FIG. 1 a situation 1), which shows 20 sub-rights (100) that all are designated as free or available sub-rights (101) as indicated by a white box.

When a first user starts access to the content, i.e. when rendering/execution of the content item is begun, then 5 sub-rights, i.e. the sub-rights for one complete rendering of the content item, will be reserved according to one embodiment. This is illustrated in FIG. 1a situation 2), which shows 15 available sub-rights (101) and 5 reserved sub-rights (102) as indicated by a hatched box. Alternatively, a different number of sub-rights may be reserved instead of the number needed for one complete rendering of the content item.

After the first user has watched about 20% (i.e. one sub-unit) of the movie, he/she pauses and will thereby have consumed/used one reserved sub-right. This situation is illustrated in FIGS. 1a-3), which shows that 15 sub-rights (101) still are available, that 4 sub-rights (102) still are reserved (preferably specifically for the first user), and that 1 sub-right (103) has been used as indicated by a black box.

If now a second user starts the content, then the number of available sub-rights drop to 10 since an additional 5 sub-rights are reserved (preferably specifically for the second user). This situation is illustrated in FIGS. 1a-4), which shows that 10 sub-rights (101) still are available, that 9 sub-rights (102) now are reserved, and that I sub-right (103) have been used.

If both the first and the second user each have continued to watch an additional 20% and no additional user has accessed the content then the situation is according to FIGS. 1a-5) where 10 available sub-rights (101), 7 reserved sub-rights (102) and 3 used sub-rights (103) are shown.

In this way, a track is kept of how many sub-rights are still needed for users who are currently somewhere in the middle of consuming the content item so it is ensured that they will be able to finish it at a later time. Additionally, this is ensured in a very simple and efficient way.

FIG. 1b schematically illustrates sub-rights for a given content item according to an alternative embodiment of the present invention. Shown is the example of FIG. 1a (although shortened), but where a sub-right gives the right to access a specific sub-part. Using the example from FIG. 1a there is shown the situation, at the top of the figure, where a group of users have acquired 4 rights to watch a movie once, where the movie consists of 5 sub-parts, resulting in 20 acquired sub-rights (100). Each sub-right is for a specific sub-part as is indicated by the number in each sub-right (100). The shown ordering is not important and could e.g. have been 5,5,5,5,4,4,4, etc. or any other ordering.

Second from the top is shown the situation (corresponding to 3) in FIG. 1a) where a first user has initiated access to the content item and watched 20% of it, resulting in 15 available sub-rights (101), 4 reserved sub-rights (102) and I used sub-right (103). Since a sub-right (100) specifies a specific sub-part there is sub-rights for 3 additional complete viewings of the movie but the first user may only access the last 80% of the movie (sub-parts 2,3,4,5) as the first sub-part have been accessed.

Third from the top is shown the situation (corresponding to 4) in FIG. 1a) where a second user now initiates viewing of the movie resulting in additional 5 available sub-rights (101) to be reserved bringing the available sub-rights (101) to 10 and the reserved sub-rights (102) to 9 and where still only a single sub-right have been used (103).

Fourth from the top is shown the situation (corresponding to 5) in FIG. 1a) where the first and the second user, each have watched an additional 20% of the content item, resulting in 10 available, 7 reserved sub-rights (102) and 3 used sub-rights (103).

Hereby, a track is kept of how many sub-rights are stilt needed for users who are currently somewhere in the middle of consuming the content item so it is ensured that they will be able to finish it at a later time while at the same time ensuring that a user may not use the obtained sub-right for viewing a single sub-part multiple times.

FIG. 2a schematically illustrates one example of a (part of a) data structure according to the present invention. Shown is a representation of a simple data-structure (204) comprising a first part (201) for representing and keeping track of available sub-rights, a second part (202) for representing and keeping track of reserved sub-rights and optionally a third part (203) for representing and keeping track of used sub-rights.

If each sub-right does not specify a specific sub-part, the first part (201) should comprise information identifying the relevant content item (if that information is necessary or useful) and simply the number of available sub-rights. When a number of sub-parts is reserved or used that number is simply deducted from the number of available sub-rights. The second part (202) comprises quite simply the number of reserved sub-rights. When a number of reserved sub-right is used (e.g. by continuing a paused access) that number is simply deducted from the number-of reserved sub-rights. The third part (203) comprises a number that keeps track of how many sub-rights that have been used. When a number of sub-rights is used that number is added to the existing number of used sub-rights.

Using the example from FIG. 1a, situations 1)-5) would have the first part (201) comprising: 20; 15; 15; 10; 10, respectively. The second part (202) would comprise: 0; 5 (e.g. for first user); 4 (e.g. for first user); 9 (or e.g. 4 for 1. user and 5 for 2. user); 7 (or e.g. 3 for 1. user and 4 for 2. user), respectively. The (optional) third part (203) would comprise: 0; 0; 1; 1; 3, respectively. The third part (203) is not necessary for the invention but may be useful for other application, such as statistics, etc. Various well known techniques may be used to implement the data structure (204).

FIG. 2b schematically illustrates one example of a (part of a) data structure according to an alternative embodiment of the present invention. Shown is a representation of a simple data-structure (205) corresponding to the one in FIG. 2a with the exception that sub-right refer to a specific sub-part (310) of a content item (304). Therefore the first part (201), the second part (202) and the optional third part (203) links to or references the specific sub-parts (310) of the relevant content item (304) as indicated by the arrow. The shown example corresponds to the situation fourth from the top in FIG. 1b. Other Variations may be implemented instead, e.g. one instance for each content item (304) even if they are identical (thereby making it four in this example) instead of only a single instance of the content item (304) being referenced multiple times, as in the shown example.

Various well-known techniques may be used to implement the data structure (205).

FIG. 3 schematically illustrates an embodiment of a system according to the present invention, Shown is a conditional access system (300) comprising or having access to one or more digital rights (303) arranged as previously described in a number of su-rights (100) and one or more content items (304) arranged as previously described in a number of subparts (310). Also shown are a number of users (301) forming a group of users (302).

The system (300) comprises a memory (309) and/or a storage (306) for short and/or long term storage of data, information, intermediate data, etc., communication means (308) e.g. for receiving content items (304) and digital rights (303), and optionally a display for presenting content items (304) to a user (301). The system (300) further comprises a microprocessor/reservation mechanism (311) for handling the digital rights, sub-rights, content items and subparts according to the present invention as described earlier and in connection with FIGS. 1a, 1b, 2a and 2b.

The various units may communicate via a data/information bus (305) or similar type of structures.

The reservation mechanism (311) may be implemented at content item source, i.e. location of entry of the content item, or at content item sink, i.e. location of exit of the content item before it is viewed, heard, etc. by the user (301).

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of providing conditional access to a data content item (304) for a number of users (302), comprising:
associating the data content item (304) with a digital right (303), the digital right (303) providing any user (301) of a group of users (302) the right to access the data content item (304) a predetermined number of times, and where the data content item (304) is arranged in a number of subparts (310) and the digital right (303) is arranged in a number of sub-rights (100), initially designated as available sub-rights (101), each available sub-right (101) providing any user (301) of the group of users (302) the right to access a subpart (310) of the data content item (304),
granting a user (301) of the group of users (302) access to the data content item (304) if the associated digital right (303) or the available sub-right allows, and
reserving a number of available sub-rights (101), resulting in a number of reserved sub-rights (102), when a user (301) of the group of users (302) initiates granted access to the data content item (304) as a new access session.

2. The method according to claim 1, characterized in that the step of reserving a number of available sub-rights (101) comprises reservation of a number of sub-rights (101) that is required to access the complete content item once if there are sufficiently many available sub-rights (101).

3. The method according to claim 1, characterized in that the method further comprises
consuming one available sub-right (101) or a reserved sub-right (102) when a sub-part (310) is accessed by a user (301) of the group of users (302) resulting in a spent sub-right (103) that no longer is available.

4. The method according to claim 1, characterized in that a specific available sub-right (101) only allows access to a specific sub-part (310) of the data content item (304), or that a specific available sub-right (101) allows access to any sub-part (310) of the data content item (304).

5. The method according to claim 1, characterized in that the step of reserving a number of available sub-rights (101) comprises
reserving the number of sub-rights (101) so that only the user that initiated granted access to the data content item (304) is able to continue access to the data content item (304) using reserved sub-rights (102), or reserving the number of sub-rights (101) so that all the users belonging to the group comprising the user that initiated granted access to the data content item (304) is able to continue access to the data content item (304) using reserved sub-rights (102).

6. The method according to claim 1, characterized in that the step of reserving a number of available sub-rights (101) is only done when the user (301) that initiated granted access is expected to complete access to substantially all of the data content item (304).

7. The method according to claim 1, characterized in that the method further comprises canceling, by a user, the reservation of a number of reserved sub-rights (102) thereby freeing sub-rights (100) resulting a number of available sub-rights (101) for the group of users (302), where only the user that initiated granted access to the content item (304) is allowed to cancel or where all the users belonging to the group comprising the user that initiated granted access to the data content item (304) is allowed to cancel.

8. A conditional access system (300) for providing conditional access to a data content item (304) for a number of users (302), comprising:
the data content item (304) being associated with a digital right (303), the digital right (303) providing any user (301) of a group of users (302) the right to access the data content item (304) a predetermined number of times, and where the data content item (304) is arranged in a number of subparts (310) and the digital right (303) is arranged in a number of sub-rights (100), initially designated as available sub-rights (101), each available sub-right (101) providing any user (301) of the group of users (302) the right to access a subpart (310) of the data content item (304),
means (311) for granting a user (301) of the group of users (302) access to the data content item (304) if the associated digital right (303) or the available sub-right(s) (101) allows this, and
means (311) for reserving a number of available sub-rights (101), resulting in a number of reserved sub-rights (102), when a user (301) of the group of users (302) initiates granted access to the data content item (304) as a new access session.

9. The system according to claim 8, characterized in that the means (311) for reserving a number of available sub-rights (101) is adapted to reserve of a number of sub-rights (101) that is required to access the complete content item once if there are sufficiently many available sub-rights (101).

10. The system according to claim 8, characterized in that the system further comprises
means (311) for consuming one available sub-right (101) or a reserved sub-right (102) when a sub-part (310) is accessed by a user (301) of the group of users (302) resulting in a spent sub-right (103) that no longer is available.

11. The system according to claim 8, characterized in that a specific available sub-right (101) only allows access to a specific sub-part (310) of the data content item (304), or that a specific available sub-right (101) allows access to any sub-part (310) of the data content item (304).

12. The system according to claim 8, characterized in that the means (311) for reserving a number of available sub-rights (101) is adapted to
reserve the number of sub-rights (101) so that only the user that initiated granted access to the data content item (304) is able to continue access to the data content item (304) using reserved sub-rights (102), or
reserve the number of sub-rights (101) so that all the users belonging to the group comprising the user that initiated granted access to the data content item (304) is able to continue access to the data content item (304) using reserved sub-rights (102).

13. The system according to claim 8, characterized in that reserving a number of available sub-rights (101) is only done when the user (301) that initiated granted access is expected to complete access to substantially all of the data content item (304).

14. The system according to claim 8, characterized in that the system further comprises
means (311) for canceling, by a user, the reservation of a number of reserved sub-rights (102) thereby freeing sub-rights (100) resulting a number of available sub-rights (101) for the group of users (302), where only the user that initiated granted access to the content item (304) is allowed to cancel or where all the users belonging to the group comprising the user that initiated granted access to the data content item (304) is allowed to cancel.

15. A computer readable medium having stored thereon instructions for causing one or more processing units to execute actions comprising:
associating the data content item with a digital right, the digital right providing any user of a group of users the right to access the data content item a predetermined number of times, and where the data content item is arranged in a number of subparts and the digital right is arranged in a number of sub-rights, initially designated as available sub-rights, each available sub-right providing any user of the group of users the right to access a subpart of the data content item;
granting a user of the group of users access to the data content item if the associated digital right or the available sub-right allows; and
reserving a number of available sub-rights, resulting in a number of reserved sub-rights, when a user of the group of users initiates granted access to the data content item as a new access session.
